(19) United States
(12) Patent Application Publication
(10) Pub. No.: US 2005/0082168 A1
(43) Pub. Date: Apr. 21, 2005

(54) Apparatus of electrophoresis

(76) Inventor: Jing X. Kang, North Andover, MA (US)

Correspondence Address: Melissa Patangia,Lambert & Associates;2nd Floor, 92 State Street, Boston, MA, 02109, US

(21) Appl. No.: 10/967,767

(22) Filed: Oct. 18, 2004

Related U.S. Application Data
(60) Provisional application No. 60/512,331, filed on Oct. 17, 2003.

(51) Int. Cl. G01N 27/453

(52) U.S. Cl. 204/456; 204/606

(57) ABSTRACT

The purpose of the present invention is to provide a novel electrophoresis apparatus, with a built-in illuminator system, that has a functional feature of viewing or monitoring or photographing the separation status of DNA or RNA anytime during and after electrophoresis on site.

### CROSS-REFERENCE TO RELATED APPLICATIONS

This application is based on and claims priority from provisional patent application Ser. No. 60/512,331 filed on Oct. 17, 2003.

### FIELD OF THE INVENTION

The present invention relates generally to the field of biochemical analysis and in particular to a novel apparatus and method for DNA/RNA electrophoresis.

### BACKGROUND OF INVENTION

Analysis (separation) of DNA/RNA materials by agarose gel electrophoresis is a common practice of biochemical laboratories. Thus, the electrophoresis apparatus is the essential piece of equipment for every biochemical laboratory. The existing apparatus for DNA/RNA electrophoresis does not have an illuminating function that allows one to view or monitor the separation status during and after electrophoresis on site. To view and photograph the DNA/RNA in the gel, one has to transfer the agarose gel containing DNA or RNA from the apparatus to a dark room, wear a UV protection shelter and use a UV transilluminator. This practice is very inconvenient, time consuming and requires additional expensive equipments (e.g., dark room, UV shelter, UV transilluminator and viewing adopters). For these reasons a novel apparatus for electrophoresis is needed.

### SUMMARY OF THE INVENTION

The principal object of the present invention is to provide a novel electrophoresis apparatus that has a functional feature of viewing or monitoring the separation status of DNA or RNA anytime during and after electrophoresis on site, without the need of transferring the gel, wearing protection shelter and utilizing an additional UV transilluminator. The manner with which the Applicant has accomplished the objective and solved the aforementioned problems is to invent a unique and novel electrophoresis apparatus that has a built-in illuminator system.

These and other features, aspects and advantages of the present invention will become better understood with reference to the following description, claims, and accompanying drawings. Therefore, the form of the invention, as set out above, should be considered illustrative and not as limiting the scope of the following claims.

### BRIEF DESCRIPTION OF DRAWINGS

FIG. 1A is a sectional view of the apparatus of the present invention;

FIG. 1B is a transparent (see-through) view of the electrophoresis chamber showing the internal layout of the gel platform and the UV lighthouse;

FIG. 1C is a perspective view of the apparatus of this invention;

FIG. 2 is a transparent (see-through) view of the cover showing the alternate embodiment in which the UV lamps are installed underneath the cover;

FIG. 3 is a perspective view of the gel platform and the clamp used to cast gel on the platform.

### DESCRIPTION OF THE INVENTION

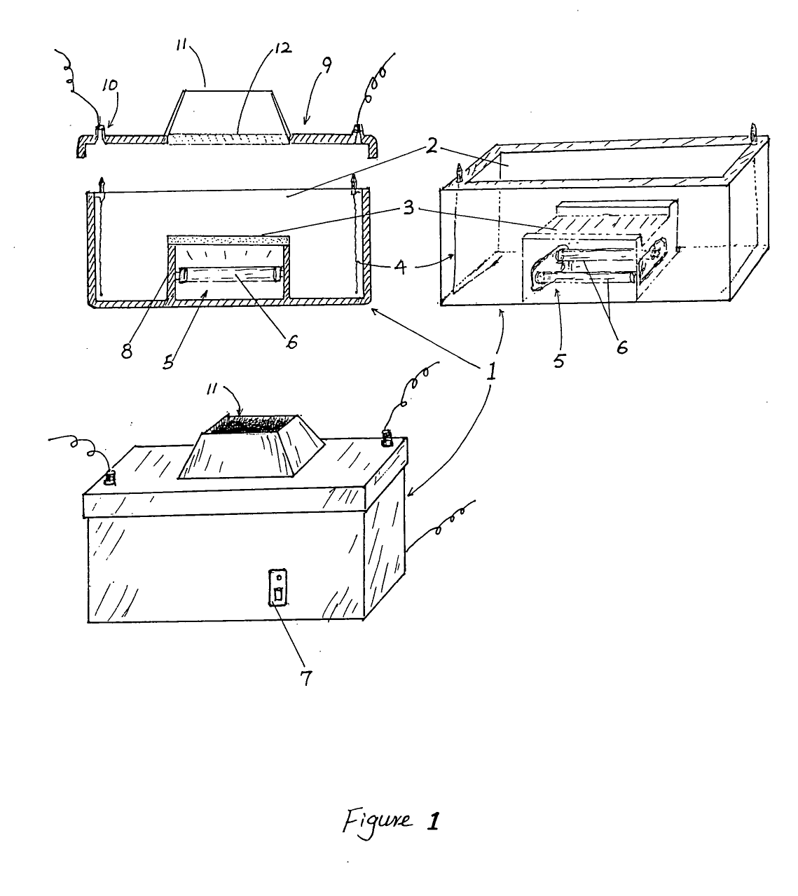

The preferred embodiment of the present invention represents an apparatus for electrophoresis as shown in FIGS. 1-3.

With reference to FIGS. 1A, 1B, and 1C, FIGS. 1A, 1B, and 1C depict the electrophoresis chamber 1 of the present invention. The electrophoresis chamber 1 of the present invention is the body of the apparatus. The electrophoresis chamber 1 resembles a rectangular box which can be made from light-proof or dark-colored plastic, metal or other similar materials. The electrophoresis chamber 1 is comprised of the buffer chamber 2, the gel platform 3, and two electrodes 4. The buffer chamber 2 is used to contain the electrophoresis buffer solution. The gel platform 3 is located in the center of the electrophoresis chamber 1 and is used to hold the electrophoresis agarose gel. The materials used to make the gel platform 3 are UV-transparent or UV-transmittable and allow the UV light to penetrate it. The two electrodes 4 are set in each end of the electrophoresis chamber 1 and connect to the electrical power.

With further reference to FIGS. 1A, 1B, and 1C, FIGS. 1A, 1B, and 1C depict the UV lighthouse 5 which is underneath the gel platform 3. The UV lighthouse 5 is composed of one or more UV lamps 6 and a power switch 7. The bottom of the UV lighthouse 5 is a light reflector which concentrates the light upward. The top of the UV lighthouse 5 is the gel platform 3 made from UV-transparent materials. The side walls 8 of the UV lighthouse 5 are made from light-proof materials. The power switch 7 is located on a side wall 8 of the UV lighthouse 5 which allows one to turn the UV lamps 6 on or off.

With further reference to FIGS. 1A, 1B, and 1C, FIGS. 1A, 1B, and 1C depict the cover 9 which is a light-proof rectangle board that has two electrode connectors 10 and a viewing window 11 on it. The viewing window 11 is located in the center, positioned above the gel platform 3. The opening of the viewing window 11 is covered with a piece of transparent material 12 that is a UV-blocker or screen that will prevent harm to the user, such as a polycarbonate lens. The transparent material 12 is capable of filtering the UV rays so that one can view the gel through the viewing window 11 without any harm. An adapter can be placed on the cover to allow one to take pictures of the gel directly.

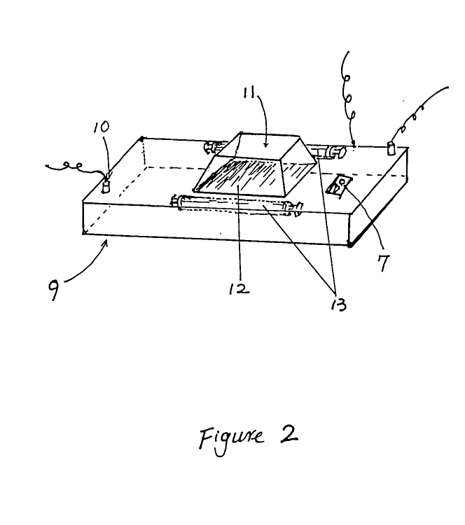

An alternate embodiment of the present invention is illustrated in FIGS. 2. Specifically FIG. 2 depicts the use of two UV lamps 13 attached to the inside of the cover 9 on the two opposite sides of the viewing window 11. The two UV lamps 13 must be placed under the UV screen 12 so they do not prove harmful.

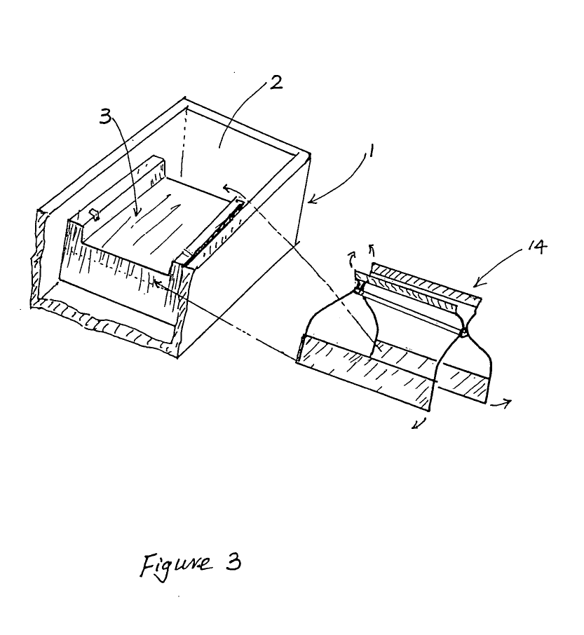

With reference to FIG. 3, FIG. 3 depicts another feature of the present invention which allows one to cast the agarose gel directly on the gel platform 3 without the need of a gel tray by using a specially-designed clamp 14. With the present invention, one can cast a gel directly on the electrophoresis chamber 1 without the need of a tray and mold. One can view and photograph the DNA or RNA image in the gel anytime on site by simply pushing a “UV ON” button, without the need of gel transfer and additional items.

As such the method of making and using the device detailed above constitute the inventor's preferred embodiment and alternate embodiments to the invention. The inventor is aware that numerous configurations of the device as a whole or some of its constituent parts are available which would provide the desired results. While the invention has been described and illustrated with reference to specific embodiments, it is understood that these other embodiments may be resorted to without departing from the invention. Therefore the form of the invention set out above should be considered illustrative.

1. An electrophoresis chamber comprising:
a buffer chamber for containing the electrophoresis buffer solution;
a gel platform located in the center of said electrophoresis chamber for containing the electrophoresis agarose gel;
two electrodes set at each end of said electrophoresis chamber and connect to the electrical power;
a UV lighthouse wherein said UV lighthouse is located underneath said gel platform and wherein the bottom of said UV lighthouse is a light reflector;
a cover that allows for the safe viewing and photographing by the user.

2. The electrophoresis chamber of claim 1 wherein said UV lighthouse comprises:
sidewalls;
at least one UV lamp; and
a power switch located on one of said sidewalls.

3. The electrophoresis chamber of claim 2 wherein said sidewalls are constructed of light-proof materials.

4. The electrophoresis chamber of claim 1 wherein said cover comprises:
two electrode connectors;
a viewing window located in the center of said cover and positioned above said gel platform; and
a transparent material covering the opening of said viewing window.

5. The electrophoresis chamber of claim 4 wherein said transparent material is a UV-blocker material that prevents the user from harm.

6. The electrophoresis chamber of claim 4 wherein said transparent material is a polycarbonate lens.

7. The electrophoresis chamber of claim 4 wherein said cover further comprises an adapter to allow for the taking of pictures.

8. The electrophoresis chamber of claim 4 wherein said cover further comprises a cover power switch and two cover UV lamps wherein said two cover UV lamps attached to the inside of said cover on the two opposite of said viewing window below said transparent material.

9. The electrophoresis chamber of claim 1 further comprising a clamp for casting an electrophoresis agarose gel directly on said gel platform.

10. The electrophoresis chamber of claim 1 wherein the body of said electrophoresis chamber is constructed of light-proof plastic.

11. The electrophoresis chamber of claim 1 wherein the body of said electrophoresis chamber is constructed of dark-colored plastic.

12. The electrophoresis chamber of claim 1 wherein the body of said electrophoresis chamber is constructed of metal.

13. The electrophoresis chamber of claim 1 wherein said gel platform is constructed of a UV-transmittable material.

14. A method of DNA electrophoresis comprising:
placing an electrophoresis agarose gel containing DNA on a gel platform located at the center of an electrophoresis chamber;
placing a cover on said electrophoresis chamber; and
illuminating said electrophoresis agarose gel containing DNA.

15. The method of DNA electrophoresis of claim 14 wherein illumination is provided by one or more UV lamps.

16. The method of DNA electrophoresis of claim 14 further comprising:
monitoring electrophoresis agarose gel containing DNA through a viewing window locating at the center of said cover.

17. The method of DNA electrophoresis of claim 14 further comprising:
photographing electrophoresis agarose gel containing DNA.

18. A method of RNA electrophoresis comprising:
placing electrophoresis agarose gel containing RNA on a gel platform located at the center of an electrophoresis chamber;
placing a cover on said electrophoresis chamber; and
illuminating said electrophoresis agarose gel containing RNA.

19. The method of RNA electrophoresis of claim 18 wherein illumination is provided by one or more UV lamps.

20. The method of RNA electrophoresis of claim 18 further comprising:
monitoring electrophoresis agarose gel containing RNA through a viewing window locating at the center of said cover.

21. The method of RNA electrophoresis of claim 18 further comprising:
photographing electrophoresis agarose gel containing RNA.
